(19) United States
(12) Patent Application Publication
(10) Pub. No.: US 2009/0219569 A1
(43) Pub. Date: Sep. 3, 2009

(54) INFORMATION PROCESSING APPARATUS, INFORMATION PROCESSING SYSTEM, AND INFORMATION PROCESSING METHOD

(75) Inventor: Kenji Hara, Kawasaki-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/390,931

(22) Filed: Feb. 23, 2009

(30) Foreign Application Priority Data
Feb. 28, 2008 (JP) 2008-048537

(51) Int. Cl. G06F 3/12

(52) U.S. Cl. 358/1.15

(57) ABSTRACT

An information processing apparatus including a packet processing unit configured to process a packet includes a transfer unit configured to transfer the packet processing unit to another information processing apparatus when the information processing apparatus shifts to a power saving state, and an apparatus information transfer unit configured to transfer the apparatus information about the information processing apparatus, which is referred to by the packet processing unit, to the another information processing apparatus when the information processing apparatus shifts to the power saving state.

### BACKGROUND OF THE INVENTION

1. Field of the Invention

The present invention relates to an information processing apparatus, an information processing system, and an information processing method.

2. Description of the Related Art

As a network environment has become widespreadly used, a printer apparatus and a multifunction peripheral (MFP) that can connect to a network have been already marketed. Accordingly, in an office environment, it has become common that a plurality of users sharedly uses a plurality of MFPs.

Furthermore, as the speed of data communication via a network has become high, a technique of Network-Attached Storage (NAS) for sharing a storage via a network has been developed, which is likely to be used as a built-in apparatus. Under such circumstances, in middle sized to large sized companies, which use a plurality of MFPs, it is necessary to set all MFPs to a standby state before activating all services.

More specifically, it is necessary to acquire device information by a protocol such as management information base (MIB) of Simple Network Management Protocol (SNMP). However, if a request by MIB is issued to a specific MFP, a network communication function and a device such as a central processing unit (CPU) and a storage device of the MFP are used. Accordingly, if an SNMP packet is received during a power saving state (power saving state), it becomes necessary for the MFP to activate the device and transmit a response thereto. Furthermore, if an application operating on the MFP always executes data communication with an external apparatus to provide a service, the MFP cannot appropriately shift to the power saving state.

In this regard, Japanese Patent Application Laid-Open No. 2006-235814 discusses a method for requesting another host (proxy server) to operate in proxy for the requesting apparatus during the power saving state. However, in the method discussed in Japanese Patent Application Laid-Open No. 2006-235814, it is necessary that the proxy server previously stores a program corresponding to the request to be received.

That is, in this conventional method, a unique application that operates on the MFP and specific information that the MFP has cannot be executed or used without changing the firmware of the proxy server. Accordingly, the processing that can be executed by proxy is limited in this case.

Meanwhile, the virtual machine technology such as VMware or xen has become common and widely used to reduce the number of servers in a system. The virtual machine technology provides a resume function that enables suspending all programs operating on an apparatus including the operating system (OS), storing the suspended state (data on a CPU register and a random access memory (RAM)) as a status file of the virtual machine, and restarting the apparatus from the suspended state.

If a plurality of MFPs includes a platform of the virtual machine technology, some of or all the programs operating on a specific MFP can be executed as they are on another MFP by transferring the same to the MFP by using the virtual machine technology.

By using the virtual machine technology, the functions of the MFPs in a low load state can be integrally executed by a specific MFP only. Accordingly, a plurality of MFPs other than the MFP integrally having the functions of the other MFPs can be appropriately shifted to the power saving state. Thus, the system having the configuration like this can effectively save power.

However, if the program on a specific MFP is executed on another MFP by using the virtual machine technology, the program and memory resources can be transferred while most of the data referred to by the program is still recorded on a storage such as a hard disk of the MFP that has shifted to the power saving state. Accordingly, the program cannot access the storage device having the necessary data. Therefore, the program on the specific MFP cannot normally operate.

### SUMMARY OF THE INVENTION

The present invention is directed to a method for shifting the state of an information processing apparatus to a power saving state and executing a service provided by the information processing apparatus by proxy.

According to an aspect of the present invention, an information processing apparatus including a packet processing unit configured to process a packet includes a transmission unit configured to transmit apparatus information about the information processing apparatus, which is referred to by the packet processing unit, to another information processing apparatus, and a transfer unit configured to transfer the packet processing unit to the another information processing apparatus when the information processing apparatus shifts to a power saving state.

According to an exemplary embodiment of the present invention, a service provided by an information processing apparatus can be executed by proxy even after the information processing apparatus has been shifted to a power saving state.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the present invention.

FIG. 1 illustrates an exemplary functional configuration of an image input/output apparatus, which is an example of an information processing apparatus including a control apparatus as an electronic component and an exemplary configuration of a system including an image input apparatus.

FIG. 2 illustrates an example of an inner configuration of a reader unit and a printer unit.

FIG. 3 illustrates an example of a control apparatus.

FIG. 4 illustrates an example of a main controller.

FIG. 5 illustrates an exemplary configuration for implementing a virtual machine.

FIG. 6 illustrates an outline of Network File System (NFS).

FIG. 7 illustrates an example of a logical partition.

FIG. 8 illustrates an exemplary software configuration of a control apparatus of an MFP-A.

FIG. 9 illustrates an exemplary software configuration of control apparatus of a MFP-B.

FIG. 10 illustrates an example of processing for applying a storage service.

FIG. 11 is a flow chart illustrating exemplary processing executed by the MFP-A at the time and after the MFP-A is activated.

FIG. 12 illustrates an exemplary configuration of a personal computer (PC).

FIG. 13 illustrates an example of processing executed by each apparatus when the MFP-A returns from a power saving state to a normal operation state.

FIG. 14 illustrates an example of an MFP-A virtual machine operating on the MFP-B.

FIG. 15 illustrates the normal operation state of the MFP-A.

FIG. 16 illustrate a state in which an MFP-A virtual machine has been in a suspended state.

FIG. 17 illustrates a state in which the MFP-A has shifted to the power saving state or a power off state.

### DETAILED DESCRIPTION OF THE EMBODIMENTS

Various exemplary embodiments, features, and aspects of the present invention will now be herein described in detail below with reference to the drawings. It is to be noted that the relative arrangement of the components, the numerical expressions, and numerical values set forth in these embodiments are not intended to limit the scope of the present invention.

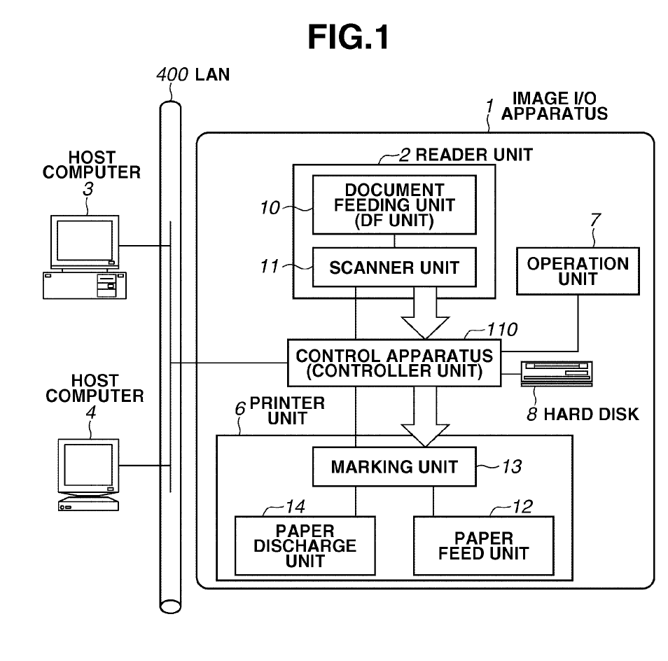

FIG. 1 illustrates an exemplary functional configuration of an image input/output (I/O) apparatus, which is an example of an information processing apparatus including a control apparatus as an electronic component and an exemplary configuration of a system including an image input apparatus. Referring to FIG. 1, an image I/O apparatus 1 is connected to a host computer (a first host computer 3 and a second host computer 4 in the present exemplary embodiment) via a local area network (LAN) 400.

The image I/O apparatus 1 includes the reader unit 2, the printer unit 6, and the operation unit 7. The reader unit 2 reads image data. The printer unit 6 outputs the read image data. The operation unit 7 includes a liquid crystal display (LCD) panel for allowing the user to input an operation for inputting and outputting image data and displaying various functions.

Furthermore, the image I/O apparatus 1 includes a hard disk 8 storing a control program and image data that have been previously written thereon.

In addition, the image I/O apparatus 1 includes a control apparatus 110 constituted by a single electronic component and connected to each of the above-described components. The control apparatus 110 controls the operation of the above-described components.

The reader unit 2 includes a document feeding unit 10 and a scanner unit 11. The document feeding unit 10 conveys a document sheet. The scanner unit 11 optically reads an image of a document and converts the read document image into image data (electronic signal). The printer unit 6 includes a paper feed unit 12 having a plurality of paper feed cassettes in which recording sheets are set and a marking unit 13 that transfers image data onto a recording sheet and fixes the image data on the sheet.

Furthermore, the printer unit 6 includes a paper discharge unit 14. The paper discharge unit 14 executes sorting and stapling on the printed recording sheets and discharges the post-processed sheets to the outside of the apparatus.

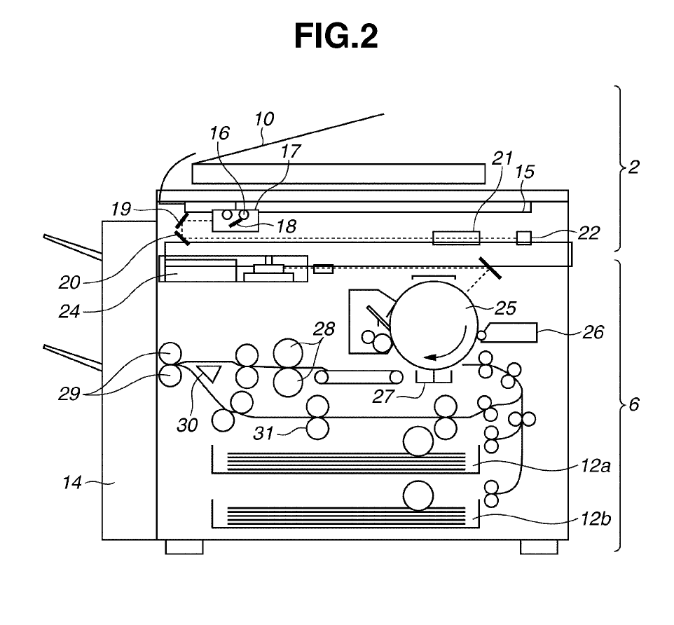

FIG. 2 illustrates an example of an inner configuration of the reader unit 2 and the printer unit 6 according to the present exemplary embodiment.

In the example illustrated in FIG. 2, the reader unit 2 is provided on the printer unit 6. In the reader unit 2, the document sheets stacked on the document feeding unit 10 are serially fed onto the platen glass 15 sheet by sheet from the top of the stack according to the stacking order. After the scanner unit 11 has completed a predetermined reading operation, the read document sheet is conveyed from the platen glass 15 to the document feeding unit 10.

Furthermore, in the scanner unit 11, when the document sheet is conveyed onto the platen glass 15, the lamp 16 is lit. Then, the scanner unit 11 starts moving the optical unit 17 and stops the optical unit 17 at a reading position. The optical unit 17 irradiates and scans the conveyed document sheet from below. Light reflected from the document sheet is guided to a charge-coupled device (CCD) image sensor (hereinafter simply referred to as a “CCD”) 22 via a plurality of mirrors 18, 19, and 20 and a lens 21. The scanned document image is read by the CCD 22. The image data read by the CCD 22 is then processed by predetermined processing. Then, the processed image data is transferred to the control apparatus 110 (omitted in Fig. 2).

Alternatively, by using the lamp 16 lit in the above-described manner, starting moving the optical unit 17, and irradiating and scanning the document sheet placed on the platen glass 15 from below, the scanned document image can be read with the CCD 22. The image data input from the reader unit 2 in the above-described manner is transferred to the control apparatus 110 via a connector.

Then, in the printer unit 6, a laser emission unit 24 emits a laser beam corresponding to the image data output from the control apparatus 110. An electrostatic latent image is formed by the laser beam on a photosensitive drum 25 of the marking unit 13. A development unit 26 applies a developer to a portion of the photosensitive drum 25 having the electrostatic latent image.

On the other hand, a recording sheet is fed from the paper feed unit 12 (paper feed cassettes 12a and 12b) and is then conveyed to a transfer unit 27 at a timing synchronizing with the start of irradiation of the laser beam. Then, the developer image on the photosensitive drum 25 is transferred on the recording sheet. The recording sheet having the transferred image data is conveyed to a fixing unit 28. The fixing unit 28 heats and presses the developer image on the recording sheet to fix the image data on the recording sheet. In recording image data on a recording sheet by a one-sided recording mode, the recording sheet that has exit from the fixing unit 28 is then discharged on the paper discharge unit 14 by a paper discharge roller 29 as it is.

The paper discharge unit 14 bundles up the discharged recording sheets, sorts out the recording sheets, and executes stapling processing on the sorted recording sheets. On the other hand, in recording image data in a two-sided recording mode, after having conveyed the recording sheet to the paper discharge roller 29, the paper discharge roller 29 is rotated in the reverse direction. Then, the recording sheet is guided by a flapper 30 into a paper refeed conveyance path 31. Then, the recording sheet is conveyed to the transfer unit 27 in the above-described manner.

As described above, the control apparatus 110 is constituted by a single electronic component. The image I/O apparatus 1 has a scanner function for converting the image data read by the reader unit 2 into code and transmitting the code to the host computers 3 and 4 via the LAN 400. In addition, the image I/O apparatus 1 includes a printer function and other functional blocks for converting the coded data received from the host computers 3 and 4 via the LAN 400 into image data and outputting the image data to the printer unit 6.

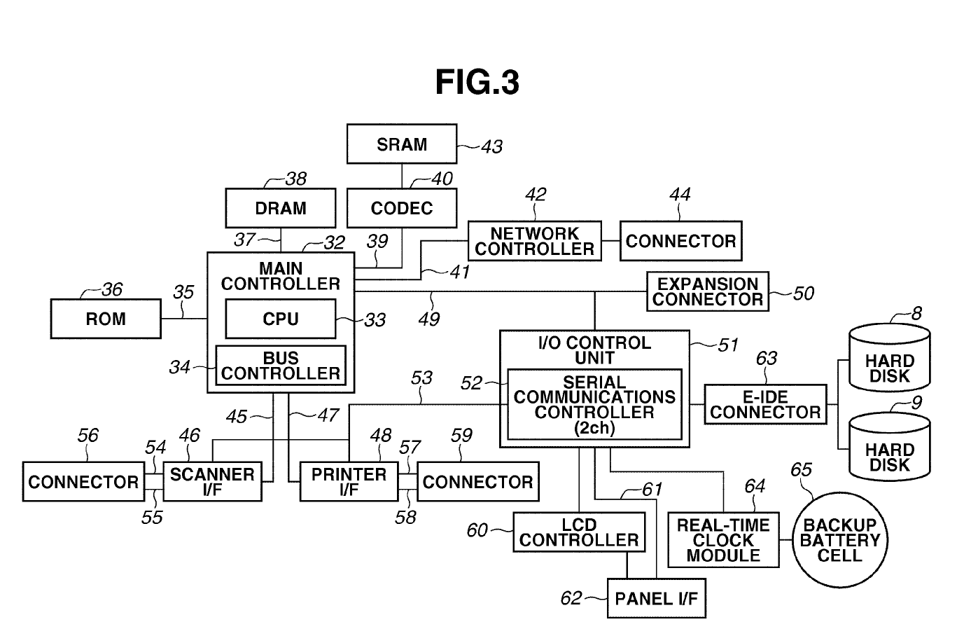

FIG. 3 illustrates an example of the control apparatus 110. A main controller 32 has a central processing unit (CPU) 33, a bus controller 34, and functional blocks including various controller circuits, which will be described in detail later below. Furthermore, the main controller 32 is connected with a read-only memory (ROM) 36 via a ROM interface (I/F) 35. In addition, the main controller 32 is connected with a dynamic random access memory (DRAM) 38 via a DRAM I/F 37.

Furthermore, the main controller 32 is connected with a codec 40 via a codec I/F 39. In addition, the main controller 32 is connected with a network controller 42 via a network I/F 41. The ROM 36 stores various control programs executed by the CPU 33 of the main controller 32 and calculation data. The DRAM 38 is used as a work area for the CPU 33 and a temporary storage area for temporarily storing image data.

The codec 40 compresses raster image data stored on the DRAM 38 by a publicly known compression method, such as Modified Huffman (MH), Modified Read (MR), Modified Modified Read (MMR), or Joint Bi-level Image Experts Group (JBIG). In addition, the codec 40 decompresses the compressed data into raster image data. Furthermore, a static random access memory (SRAM) 43 is connected to the codec 40. The SRAM 43 is used as a temporary work area of the codec 40.

The network controller 42 executes predetermined network control on the LAN 400 via a connector 44. Furthermore, the main controller 32 is connected with a scanner I/F 46 via a scanner bus 45. In addition, the main controller 32 is connected with a printer I/F 48 via a printer bus 47. The main controller 32 is also connected with an expansion connector 50, which is an interface with an expansion board, and with an I/O control unit 51 via a general-purpose high speed bus 49, such as a peripheral component interconnect (PCI) bus.

The I/O control unit 51 is equipped with two channels of asynchronous serial communication controllers 52. The serial communication controller 52 is used for transmitting and receiving a control command to and from the reader unit 2 and the printer unit 6. The serial communication controller 52 is connected with the scanner I/F 46 and the printer I/F 48 via an I/O bus 53.

The scanner I/F 46 is connected to a scanner connector 56 via a first asynchronous serial I/F 54 and a first video I/F 55. Furthermore, the scanner connector 56 is connected to the scanner unit 11 of the reader unit 2.

The scanner I/F 46 executes desired binarization processing on the image data received from the scanner unit 11. Moreover, the scanner I/F 46 enlarges or reduces the image data in a main scanning direction and/or a sub scanning direction. In addition, the scanner I/F 46 generates a control signal according to a video signal that have been transmitted from the scanner unit 11 and transfers the generated control signal to the main controller 32 via the scanner bus 45.

Furthermore, the printer I/F 48 is connected to a printer connector 59 via a second asynchronous serial I/F 57 and a video I/F 58. The printer connector 59 is connected to the marking unit 13 of the printer unit 6.

The printer I/F 48 executes smoothing processing on the image data outputted from the main controller 32 and outputs the image data to the marking unit 13. Furthermore, the printer I/F 48 outputs a control signal generated based on a video signal from the marking unit 13 to the printer bus 47. The CPU 33 operates based on the control program read from the ROM I/F 35 via the ROM 36. The CPU 33 interprets page description language (PDL) data received from the first and the second host the computers 3 and 4 and rasterizes the PDL data.

Furthermore, the bus controller 34 controls the transfer of data input and output by the scanner I/F 46, the printer I/F 48, and external devices connected to the expansion connector 50. The bus controller 34 executes arbitration if bus competition occurs. In addition, the bus controller 34 controls the transfer of data by direct memory access (DMA). More specifically, the bus controller 34 controls the data transfer between the DRAM 38 and the codec 40, the data transfer from the scanner unit 11 to the DRAM 38, and the data transfer from the DRAM 38 to the marking unit 13 to transfer the data by DMA.

Furthermore, the I/O control unit 51 is connected with a panel I/F 62 via an LCD controller 60 and a key input I/F 61. The panel I/F 62 is connected to the operation unit 7.

Furthermore, the I/O control unit 51 is connected to an electrically erasable programmable ROM (EEPROM), which is a nonvolatile memory. In addition, the I/O control unit 51 is connected to hard disks 8 and 9 via an Enhanced Integrated Drive Electronics (E-IDE) connector 63 and to a real-time clock module 64 that updates and stores date and time managed within the device. Note that the real-time clock module 64 is connected to a backup battery cell 65 to be backed up by the backup battery cell 65.

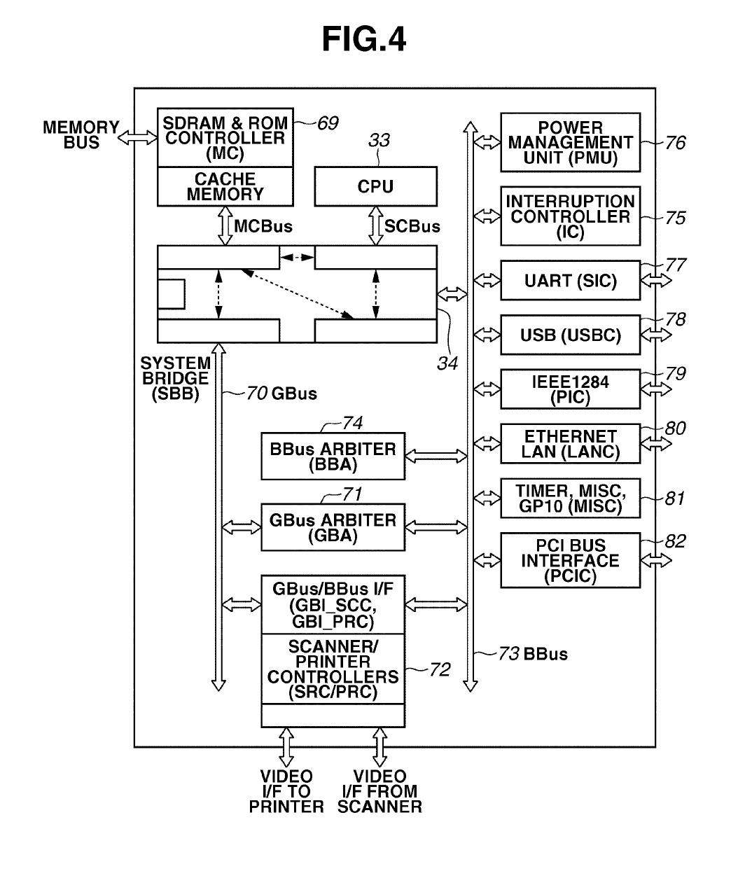

FIG. 4 illustrates an example of the main controller 32 according to the present exemplary embodiment. Referring to FIG. 4, the bus controller 34 includes a 4×4 64-bit cross bus switch. The bus controller 34 is connected to the CPU 33 via a 64-bit processor bus (P bus).

Furthermore, the bus controller 34 is connected to a memory controller 69, which includes a memory controller, via a memory-dedicated local bus (M bus). Note that the memory controller 69 is connected with a memory device such as the ROM 36 and the DRAM 38 to control the operation of the memory device.

Furthermore, the bus controller 34 is connected with a G bus arbiter 71 and a scanner/printer controller 72 via a graphics bus (G bus) 70. Moreover, the bus controller 34 is connected with the B bus arbiter 74, the G bus arbiter 71, an interruption controller 75, and various functional blocks via an I/O bus (B bus) 73. The various functional blocks include a power management unit 76, a serial I/F controller 77 such as a universal asynchronous receiver-transmitter (UART), a universal serial bus (USB) controller 78, and a parallel I/F controller 79 such as Institute of Electrical and Electronic Engineers (IEEE) 1284.

In addition, the various functional blocks include a LAN controller 80, a general-purpose I/O controller 81, a PCI bus I/F 82, and a scanner/printer controller 72. Here, the PCI bus I/F 82 is an interface between the B bus 73 and a PCI bus (external bus). The B bus arbiter 74 is an arbitration for cooperation-controlling the B bus 73. The B bus arbiter 74 receives a request for using the bus from the B bus 73, executes arbitration, and then issues a permission for using the bus to one master. Thus, the B bus arbiter 74 inhibits simultaneous access by two or more masters to the B bus 73. The arbitration method includes three priority stages. A plurality of masters is allocated to each priority stage.

The interruption controller 75 collects interruptions from each of the above-described functional blocks and devices external to the control apparatus 110 and reallocates the collected interruptions to controllers 72 and 77 through 82 supported by the CPU 33 and a non-maskable interrupt (NMI). A power management unit 76 manages power consumption of each functional block. Further, the power management unit 76 monitors the power consumption amount of the control apparatus 110 as an electronic component, which is formed by one chip. The power consumption amount of each functional block is collected in the power management unit 76 as a power management level. The power management unit 76 sums the collected power consumption amount of the functional blocks and centrally monitors the power consumption amount of the functional blocks so that the total power consumption amount does not exceed the limit of power consumption.

The G bus arbiter 71 cooperation-controls the G bus 70 by a central arbitration method. The G bus arbiter 71 includes a dedicated request signal and a dedicated permission signal to each bus master. As a method for assigning the priority to a bus master, a fair arbitration state for equally assigning a bus right to all bus masters in the same priority stage can be designated. Alternatively, a priority arbitration state for allowing any one bus master to preferentially use the bus can be used.

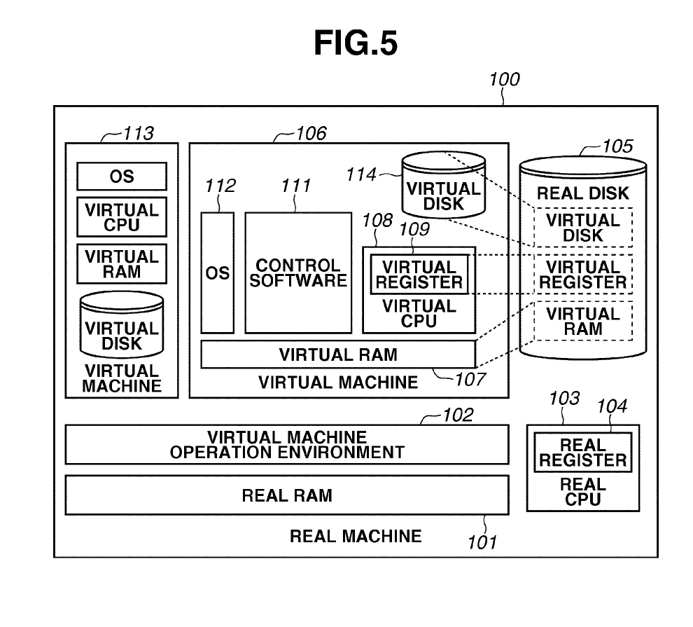

Now, an exemplary software configuration of a virtual machine that operates on the image I/O apparatus having the above-described configuration will be described in detail below. FIG. 5 illustrates an exemplary configuration for implementing a virtual machine. A virtual machine 106 is implemented as one program operating on a real machine 100. The virtual machine 106 operates on the real machine 100 at the same time as another virtual machine 113 and a virtual machine operation environment 102.

Software that operates on the virtual machine 106 implements processing by executing data communication with a device such as a CPU, a RAM, and a disk, as software on the real machine 100 does. Here, the device visible to the software on the virtual machine 106 is not a device on a real machine but a virtual device. All the virtual devices are implemented as software modules on the virtual machine 106 and emulate the real devices. Reference number 111 is control software and 112 is Operating System (OS).

For example, a virtual RAM 107 assigns an area on a work memory of the process of the virtual machine 106 to store a value in the same layout and with the same I/F as the real RAM uses. Thus, the virtual RAM 107 allows the software on the virtual machine 106 to recognize as if a real RAM exists. A virtual CPU 108 implements the same behavior as that of the real CPU 103 as a module in the virtual machine 106. The virtual CPU 108 stores the same register set as that of the real CPU 103 (i.e., the same as in the real register 104) in the area allocated on the work memory. Thus, the virtual CPU 108 allows the software on the virtual machine 106 to recognize as if a real CPU exists. Reference number 103 is real CPU and 104 is real register.

A virtual disk 114 is implemented as one file storing a bit pattern of the real disk. The entity of the file is stored on a real disk 105 on the real machine 100. Furthermore, the virtual machine 106 presents the content of the file by the same I/F as that of the real disk. Thus, the virtual disk 114 allows the software on the virtual machine 106 to recognize as if a real disk exists.

In the present exemplary embodiment, supposing that the system having the above-described configuration operates in a normal operation mode, the following operation is executed to suspend processing. That is, if the suspension of processing is instructed from the virtual machine operation environment 102 to the virtual machine 106, then the virtual machine 106 suspends the operation of the virtual CPU 108 at the timing of receiving of the instruction. Furthermore, the virtual machine 106 writes the content of a virtual register 109 on the real disk 105 as a file on the real machine 100. After that, the virtual machine 106 writes the bit pattern on the virtual RAM 107 on the real disk 105 as a file on the real machine 100. Then, the processing by the virtual machine 106 ends and the virtual machine 106 disappears from a real RAM 101.

In restarting the virtual machine 106 after suspending the processing by the virtual machine 106, the following operation is executed. That is, if the restart of the virtual machine 106 is instructed by the virtual machine operation environment 102, then processing for restarting the virtual machine 106 starts. At this time, the module on the virtual CPU 108 is not operated yet. Then, the virtual machine 106 reads the value in the virtual register 109 stored at the time the virtual machine 106 has been terminated for the previous time from the file stored on the real disk 105. Then, the virtual machine 106 sets the read value on the virtual CPU 108.

After that, the virtual machine 106 reads the value stored on the virtual RAM 107 at the last termination of the virtual machine 106 from the file on the real disk 105. Then, the virtual machine 106 sets the read value on the virtual RAM 107. Furthermore, the virtual machine 106 starts the operation of the module on the virtual CPU 108 in the state of the last termination thereof. By executing the above-described operation, the operation can be suspended while keeping the state of the components including the CPU at the time of the suspension and resumed at an arbitrary timing even when various pieces of software currently operate on the virtual machine 106.

Now, processing performed by the image I/O apparatus and the virtual machine having the above-described configuration according to an exemplary embodiment will be described in detail below. In the present exemplary embodiment, an MFP-A is an example of a first information processing apparatus, which is set to a power saving state or a power off state and becomes a source of a request of executing processing in proxy therefor. An MFP-B is an example of a second information processing apparatus that receives the proxy processing request and executes the requested proxy processing. Furthermore, in the present exemplary embodiment, a PC is an example of a third network device that issues a request to the MFP-A. Note here that most MFPs generally have the same function as that of the PC. Accordingly, the present exemplary embodiment can be applied to the system if the system executes the processing among PCs only or MFPs only. In the present exemplary embodiment, however, the above-described configuration is used for easier understanding.

The present exemplary embodiment accesses a storage device of other apparatuses via a network. In this regard, Network File System (NFS) is publicly known and commonly used. If NFS is used, it is enabled to mount a specific logical partition from the network to virtually provide a hard disk on a local kernel. A file sharing method such as Server Message Block (SMB) of Windows® can be used to virtually mount a hard disk from the network as described above. The present exemplary embodiment does not limit a protocol for sharing a storage device.

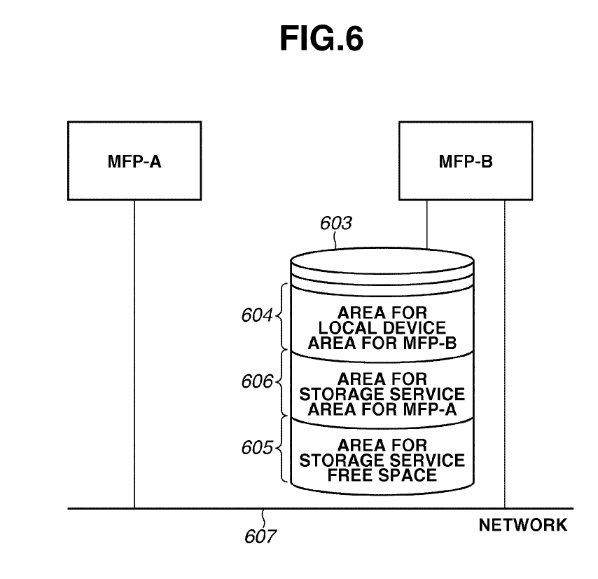

FIG. 6 illustrates an outline configuration of NFS. Referring to FIG. 6, a storage device 603 is mounted on the MFP-B. A hard disk is generally used as storage device 603. An area 604 is used by the MFP-B. An area 605 has been reserved for a storage service. The area is allocated by the MFP-B when a storage service request is received from an external apparatus.

An area 606 is assigned for the MFP-A. The MFP-A and the MFP-B are in communication with each other via a network 607. After the MFP-A has accessed a storage service target logical partition, the kernel automatically communicates with the MFP-B via the network 607 to access data stored in the area 606. The above-described operation is automatically executed by the kernel. Accordingly, if the NFS has been registered, the access is completed without causing an operator to become aware of the operation of the control program on each MFP (the MFP-A and the MFP-B).

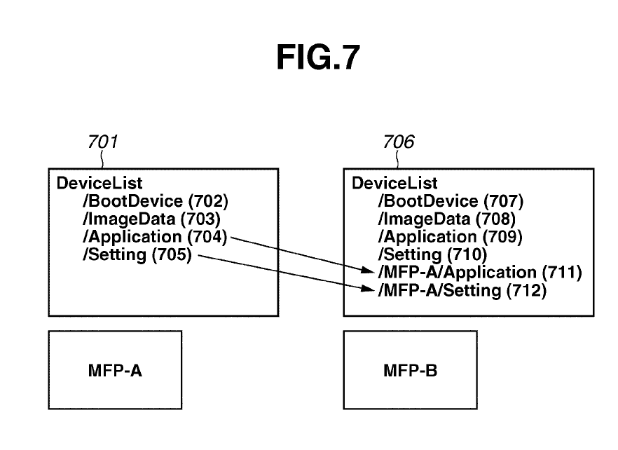

FIG. 7 illustrates an example of a logical partition according to the present exemplary embodiment. Referring to FIG. 7, a device list 701 is a list of partitions on the MFP-A. In the present exemplary embodiment, only four partitions 702 through 705 are described for easier understanding.

A boot device partition 702 includes a system boot program supposing that the MFP-A is a ROM model apparatus. If the MFP-A includes a storage device such as a hard disk, the partition can be provided on the hard disk. When the MFP-A is powered on, the MFP-A loads and executes the boot program from the boot device 702 on a memory to start its operation.

In addition, the partition list 701 includes an image device partition 703. In this regard, a digital color copying machine asynchronously executes reading of a document and an output of the read document image. Accordingly, it is necessary that a digital color copying machine includes a storage device for temporarily storing data as a page memory. If the apparatus is a ROM model, a RAM disk can be used. If the apparatus is a hard disk model, the partition is provided within the hard disk. An application partition 704 is used by an application operating on the MFP-A.

The partition is a NFS connection target partition in the present exemplary embodiment. The partition is connected to a partition 711 in the partition list 701 on the MFP-B by NFS. A device information partition 705 stores generalized information about the MFP-A. The generalized information includes information such as device name, user setting information, job history information, or information about SNMP. The device information partition 705 is connected to a partition 712 by NFS. Each partition is managed by the kernel.

When accessing each partition from the program, the program accesses the partition via a file system. In this regard, the program on the MFP-A can be written in “setfile” area in the “/Setting” partition 705 if fd=open (“/Setting/setfile”,-,-); write (fd, size, data_pointer). The device information partition 705 accesses the storage device 711 via NFS.

Similarly, an MFP-B partition list 706 includes an MFP-B boot partition 707, an MFP-B temporary image storage area 708, and an area 709 used by the application on the MFP-B. Here, the MFP-B does not use the storage service by other MFP. Accordingly, no disk is NFS-mounted thereon and the MFP-B has the entity of data on a local storage provided thereto.

MFP-B device information partition 710 stores the entity of data. Partitions 707 through 710 are equivalent to the area 604 in FIG. 6. Areas 711 and 712 are provided for the MFP-A, which correspond to the area 606 in FIG. 6. The area 711 stores the entity of the data stored on the partition 704. The area 712 stores the entity of the data stored on the device information partition 705. With the above-described configuration, the present exemplary embodiment can share a file via the network.

In the present exemplary embodiment, two partitions of the MFP-A does not use the storage service of the MFP-B to prevent failure in activating the MFP-A if the MFP-B cannot be activated due to any failure. It is important to store necessary information on a local device to secure a proper operation in a stand-alone state. Accordingly, the two partitions are targets of NFS connection in the present exemplary embodiment.

In the present exemplary embodiment, a virtualization platform is applied on the control apparatus 110 to operate software on the virtualization platform. Thus, it is enabled to transfer the software on the virtual machine on the control apparatus 110 to other MFP to execute the software thereon. In the present exemplary embodiment, the MFP-A transmits a virtual machine to the MFP-B. The MFP-A and the MFP-B have the following configuration.

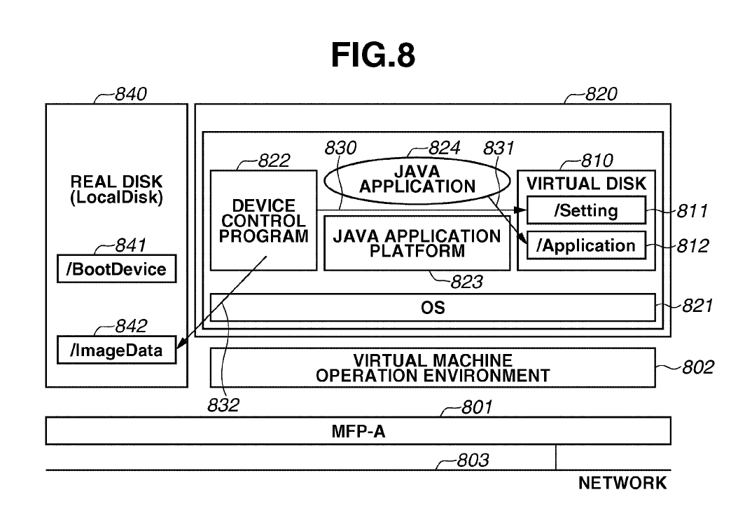

The software block on the control apparatus 110 of the MFP-A will be described in detail below with reference to FIG. 8. FIG. 8 illustrates an exemplary software configuration of the control apparatus 110 of the MFP-A according to the present exemplary embodiment. By integrally applying the same configuration to the MFP that requests proxy processing in a power saving state or in a power off state, all the MFPs can request proxy processing during the power saving state by executing the same sequence.

Referring to FIG. 8, components stacked above an MFP-A identification 801 exist on the MFP-A. A virtual machine operates on a virtual machine operation environment 802. An interface 803 is an interface between the MFP-A and an external apparatus. A local area network (LAN) can be typically used as the interface 803. The above-described partition that has been virtually mounted via NFS corresponds to a virtual disk 810.

A /Setting partition 811 is provided on the NFS. The /Setting partition 811 corresponds to the area 705 in FIG. 7. The area 712 of the MFP-B includes the entity of the /Setting partition 811. A /Application partition 812 is provided on the NFS. The /Application partition 812 corresponds to the area 704 in FIG. 7. The area 711 of the MFP-B includes the entity of the /Application partition 812. A storage provided on a local storage memory that has not been virtualized corresponds to a real disk 840.

A /BootDevice partition 841 is provided on a local disk. The /BootDevice partition 841 corresponds to the area 702 in FIG. 7. The entity of the /BootDevice partition 841 is stored within the MFP-A. A /ImageData partition 842 is provided on a local disk. The ImageData partition 842 corresponds to the area 703 in FIG. 7. The entity of the ImageData partition 842 is stored within the MFP-A. An MFP-A application 820 operates on the virtual machine. A kernel 821 operates on the virtual machine.

An MFP-A device control program 822 operates on the kernel 821. In the present exemplary embodiment, the device control program 822 is a device control program for the MFP-A itself. The device control program 822 controls an operation unit of the MFP-A and enables executing a job control. Although the device control program 822 can operate on the virtual machine operation environment 802, it is not always necessary to do so. A Java® application 823 is a platform for operating an application that can be plugged in on the MFP-A after purchase. If a Java-virtual machine is provided on the Java application platform 823, the Java application platform 823 can operate a Java application 824, which operates thereon.

An arrow 830 indicates that the device control program 822 accesses the /Setting partition 811. An arrow 831 indicates that the Java application 824 accesses the /Application partition 812. An arrow 832 indicates that the device control program 822 accesses the ImageData partition 842.

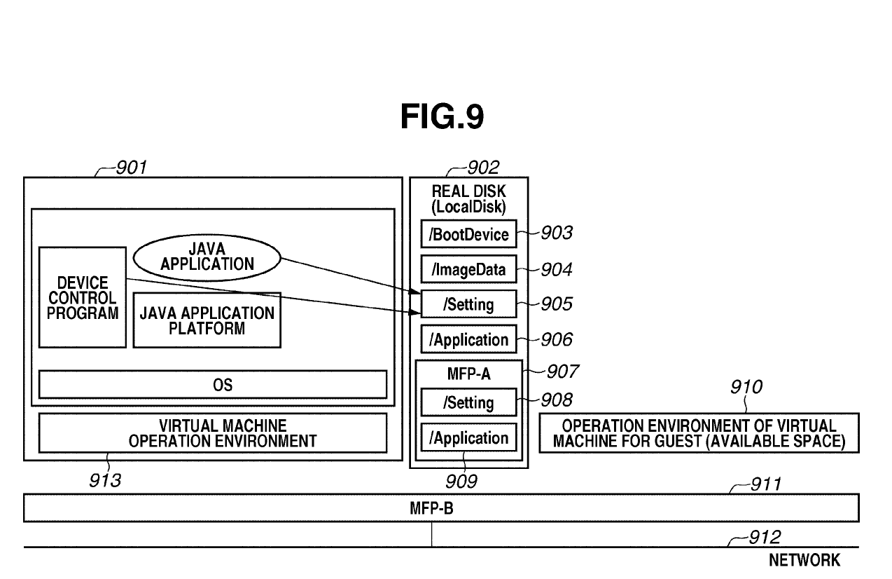

The software block on the control apparatus 110 of the MFP-B will be described in detail below with reference to FIG. 9. FIG. 9 illustrates an exemplary software configuration of the control apparatus 110 of the MFP-B according to the present exemplary embodiment. Note here that the MFP-B has a virtualization platform and a configuration substantially similar to that of the MFP-A. Accordingly, an area 901 illustrated in FIG. 9 has the same configuration as that illustrated in FIG. 8. Therefore, the description thereof will not be repeated here.

Referring to FIG. 9, components stacked above an MFP-B identification 911 exist on the MFP-B. An interface 912 is an interface between the MFP-B and an external apparatus. A LAN can be typically used as the interface 912. A storage provided on a local storage memory that has not been virtualized corresponds to a real disk 902.

A /BootDevice partition 903 is provided on a local disk. The /BootDevice partition 903 corresponds to the area 707 in FIG. 7. The entity of the /BootDevice partition 903 is stored within the MFP-B. A /ImageData partition 904 is provided on a local disk. The ImageData partition 904 corresponds to the area 708 in FIG. 7. The entity of the ImageData partition 904 is stored within the MFP-B. A /Setting partition 905 is provided on the local disk. The /Setting partition 905 corresponds to the area 710 in FIG. 7. The entity of the /Setting partition 905 is stored within the MFP-B. The control application of the MFP-B uses the /Setting partition 905.

A /Application partition 906 is provided on the local disk. The /Application partition 906 corresponds to the area 709 in FIG. 7. The entity of the /Application partition 906 is stored within the MFP-B. The Java application of the MFP-B uses the /Application partition 906. An MFP-A storage area 907 is provided on the storage service of the MFP-B and corresponds to the area 606 in FIG. 6. The storage area 907 is generated on the local disk of the MFP-B.

An MFP-A /Setting partition 908 is accessed from the /Setting partition 811 via NFS. An MFP-A /Application partition 909 is accessed from the /Application partition 812 via NFS. A guest virtual machine operation environment 910 is an environment on which a virtual machine of another MFP operates. Here, it is useful if the same environment is used for a virtual machine operation environment 913 and the virtual machine operation environment 802.

In the example illustrated in FIG. 8, the partitions 811 and 812 of the MFP-A are connected to the MFP-B. Now, processing for connecting the partitions to the MFP-B will be described in detail below. In the present exemplary embodiment, the MFP-B executes the processing in proxy for the MFP-A if the MFP-A is in the power saving state. In this regard, it is necessary to set a proxy machine (the MFP-B) and execute processing for receiving a storage resource from the proxy machine. That is, it is necessary to execute processing for transferring the partitions 811 and 812 of the MFP-A from the real disk 840 on the local disk to the virtual disk. The above-described processing is referred to as “application of storage service” in the present exemplary embodiment.

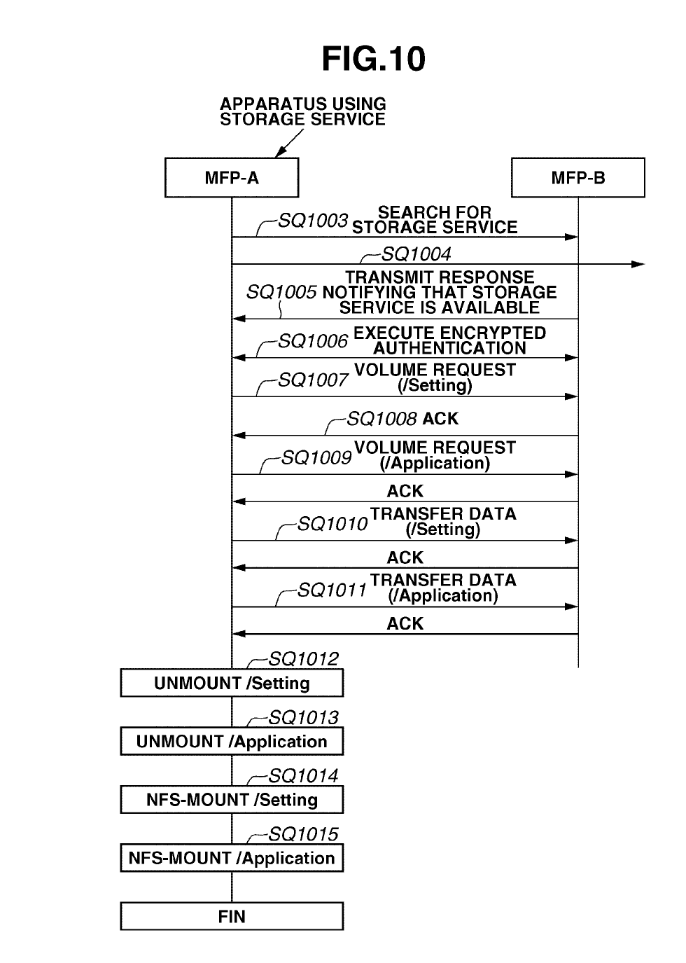

FIG. 10 illustrates an exemplary sequence for applying the storage service. Note that the sequence in FIG. 10 is executed when an event that uses the storage service on the MFP-A has been issued. Referring to FIG. 10, in sequences SQ1003 and SQ1004, the MFP-A issues a search packet for the storage service by broadcast, for example. The request in sequence SQ1003 is transmitted to the MFP-B. The request in sequence SQ1004 is transmitted to the other MFPs.

Here, it may be read from the description in FIG. 10 that the MFP-A transmits a search packet separately in sequences SQ1003 and SQ1004. However, the sequences SQ1003 and SQ1004 are separately illustrated for easier understanding and the MFP-A actually transmits the search packets at the same time. In sequence SQ1005, the MFP-B notifies the MFP-A that the MFP-B provides a storage service. At the same time, the MFP-B notifies information such as an Internet protocol (IP) address of the MFP-B and the free capacity of the storage service to the MFP-A.

In sequence SQ1006, the MFP-A and the MFP-B execute encrypted authentication. In executing data communication via a network, it is useful to encrypt the transmitted data to ensure a high data security. As a method for encrypting data transmitted via a network, Security Architecture for Internet Protocol (IPsec), which encrypts data in the network layer and is widely used, can be used in the present exemplary embodiment. However, the present exemplary embodiment is not limited to a specific data encryption method. That is, a method capable of normally exchanging a key to establish encrypted data communication can be used.

In sequence SQ1007, the MFP-A issues a request for generating an MFP-A /Setting partition. In sequence SQ1008, the MFP-B transmits an ACK indicating that the MFP-A /Setting partition has been normally generated.

In sequence SQ1009, the MFP-A issues a request for generating an MFP-A /Application partition. In sequence SQ1010, the MFP-B transmits an ACK indicating that the MFP-A /Application partition has been normally generated. By executing the above-described processing, the partitions 908 and 909 on the storage area 907 in FIG. 9 are generated.

In sequence SQ1010, the MFP-A copies all data from the MFP-A /Setting partition to the partition 908. The data file is copied by using a unique protocol at this time. Note that the MFP-A can be mounted on a different volume and the data in the MFP-A /Setting partition can be copied via NFS.

In sequence SQ1011, the MFP-A copies all data from the MFP-A /Application partition to the partition 909. The data file is copied by using a unique protocol at this time. Note that the MFP-A can be mounted on a different volume and the data in the MFP-A /Application partition can be copied via NFS. At this time, the data in the MFP-A /Setting partition and the MFP-A /Application partition has been copied in the storage area 907 of the MFP-B.

In sequence SQ1012, the MFP-A unmounts the /Setting partition (not illustrated) that has existed on the real disk 840 in FIG. 8. In sequence SQ1013, the MFP-A unmounts the /Application partition that has existed on the real disk 840 in FIG. 8. In sequence SQ1014, the MFP-A NFS-mounts the /Setting partition 811 on the virtual disk 810 in FIG. 8. In sequence SQ1015, the MFP-A NFS-mounts the /Application partition 812 on the virtual disk 810 in FIG. 8.

By executing the above-described processing, the MFP-A /Setting partition and the MFP-A /Application partition that have been locally used on the MFP-A can be copied on the MFP-B. Accordingly, any access thereafter can be executed on a local hard disk of the MFP-A via the network.

In the present exemplary embodiment, the MFP-B operates in proxy for the MFP-A because in the present exemplary embodiment, it is supposed that the MFP-A is a small size MFP that does not include a mass storage device such as a hard disk drive (HDD). That is, the MFP-B operates in proxy for the MFP-A in the present exemplary embodiment to implement an operation executed in an environment virtually including an HDD by using a storage service even if no mass storage device is locally provided.

In this regard, it is also useful, in the case where the MFP-A includes a local hard disk having a sufficiently large capacity, if the MFP-A /Setting partition and the MFP-A /Application partition are kept mounted and the data on the MFP-A can be copied in a corresponding partition on the MFP-B by soft mirroring. In this case, the MFP-A can operate by using the cache memory of itself even if the MFP-B cannot be activated while operating as a device slave to the MFP-B. Accordingly, the present exemplary embodiment can include a very stable configuration. By executing the above-described processing, the present exemplary embodiment can implement the method for applying the MFP-A storage service.

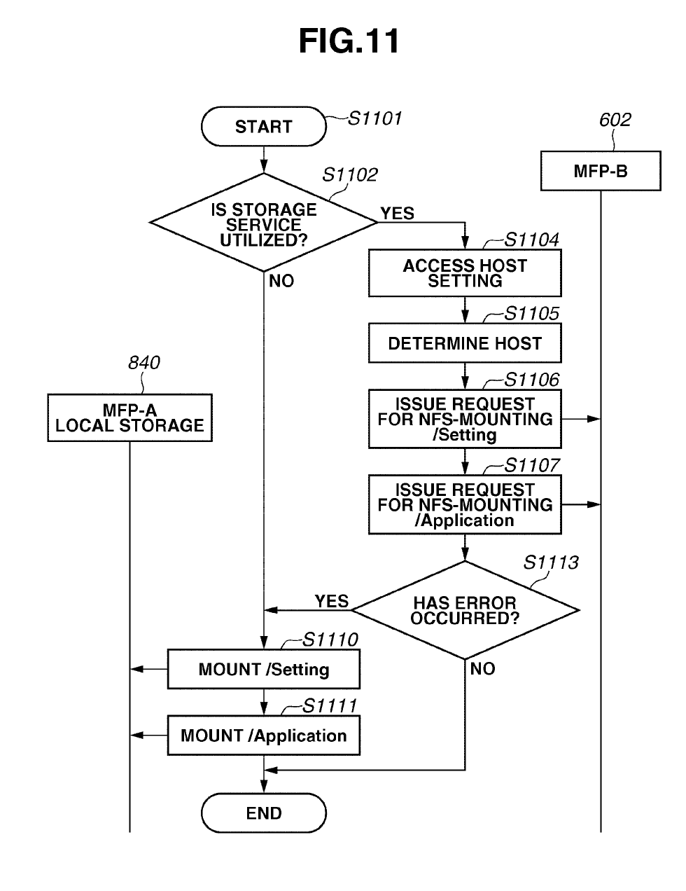

Now, an outline of processing for automatically connecting the storage service at the time of starting the MFP-A will be described below. FIG. 11 is a flow chart illustrating exemplary processing executed by the MFP-A at the time of and after being booted up. After having been powered on, the MFP-A starts processing in step S1101.

In step S1102, the MFP-A determines whether the MFP-A has been using the storage service. If it is determined in step S1102 that the MFP-A has not been using the storage service (NO in step S1102), then the processing advances to step S1110 and then to step S1111. In steps S1110 and S1111, the MFP-A mounts the MFP-A /Setting partition and the MFP-A /Application partition, respectively, from the local storage. On the other hand, if it is determined in step S1102 that the MFP-A has been using the storage service (YES in step S1102), then the processing advances to step S1104. In step S1104, the MFP-A accesses a setting of a host providing the storage service. In step S1105, the MFP-A determines a storage service request target host.

In steps S1106 and S1107, the MFP-A transmits a request for NFS-mounting the two partitions to the MFP-B. In step S1113, the MFP-A acquires information about whether the partitions have been normally mounted from the MFP-B (whether an error has occurred during mounting the partitions). If it is determined in step S1113 that the partitions have not been normally mounted (YES in step S1113), then the processing advances to step S1110. On the other hand, if it is determined in step S1113 that the partitions have been normally mounted (NO in step S1113), then the processing according to the flow chart in FIG. 11 ends. By executing the above-described processing, the present exemplary embodiment can connect the once-set storage service again after the MFP-A is powered off or on and use the storage service as if a local storage device is included in the MFP-A.

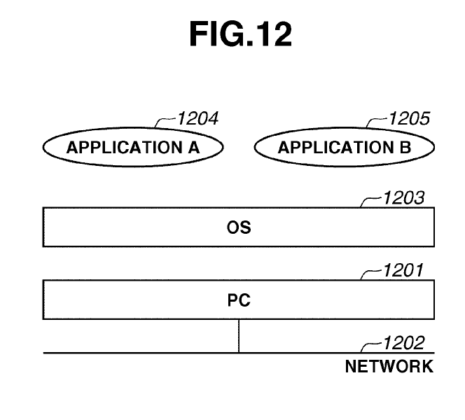

In the present exemplary embodiment, the MFP-A operates in cooperation with an external PC. In this regard, FIG. 12 illustrates an exemplary configuration of the external PC according to the present exemplary embodiment. Referring to FIG. 12, components stacked on and above a PC platform 1201 operate on the platform. The PC platform 1201 executes data communication with the MFP via a network 1202. An OS 1203 operates on the platform 1201.

An application A 1204 operates on the OS 1203. The application A 1204 periodically polls the SNMP of the MFP-A with a predetermined time interval and displays latest device information on a screen. The PC transmits a packet via the network 1202. The MFP-A receives the packet via the network 803 (FIG. 8).

By executing a socket communication for transmitting a packet, an application that has been waiting for a packet can receive the transmitted packet. In the present exemplary embodiment, the device control program 822 interprets an SNMP packet. Furthermore, the device control program 822 acquires information from the storage device and transmits the acquired information to a request source apparatus. The MIB information can include various data according to a protocol defined by Request for Comments (RFC). Furthermore, by using various MIB enhanced by different network device vendors, the MIB information can include data having very many items such as job history or information about a paper feed stage.

An application B 1205 operates on the OS 1203. The application B 1205 is client software for the Java application 824. If the Java application 824 (server software) cannot always access the application B 1205, then it is determined that a communication error has occurred. In this regard, the Java application 824 can normally access the application B 1205 by executing a socket communication via the network as described above.

An MFP used in business sites of a company primarily includes various advanced functions of an image output apparatus and can also operate as a server apparatus in various ways. In an environment in which an MFP operates as a server, if the server is powered off during a data communication, a communication error may occur. Therefore, such a server cannot be powered off according to the purpose of use thereof in the system. That is, conventionally, it is necessary in some cases to keep all MFPs having a server function powered on merely to make an inquiry to the MFP during uncomplicated processing executed while the system is in an idle state.

In order to address the problem like this, the present exemplary embodiment uses an MFP that integrally includes and can implement the server functions in proxy for the other apparatuses. Accordingly, in the present exemplary embodiment, the other MFPs can shift to the power saving state without causing a functional error. Thus, the present exemplary embodiment can implement a network system including a plurality of MFPs in which MFPs other than the one integrally having the server functions can be powered off or shifted to the power saving state without causing a functional error.

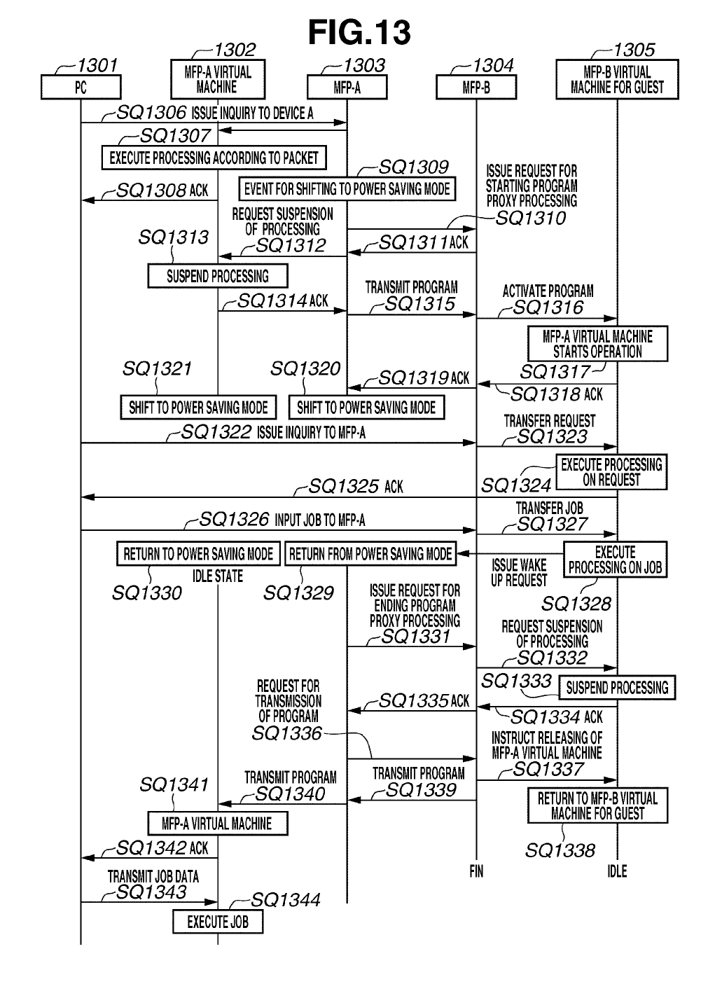

FIG. 13 illustrates an example of processing executed by each apparatus when the MFP-A shifts to the power saving state and returns from the power saving state to a normal operation mode according to the present exemplary embodiment. Referring to FIG. 13, a PC 1301 is a PC equivalent to the PC described above with reference to FIG. 12. An apparatus 1302 includes components provided on the virtual machine operation environment 802 (FIG. 8) (hereinafter simply referred to as an “MFP-A virtual machine 1302”). An environment 1303 is a non-virtual machine operation environment for the MFP-A 801 (FIG. 8) (hereinafter simply referred to as an “MFP-A 1303”). An environment 1304 is a non-virtual machine operation environment for the MFP-B 911 (FIG. 9) (hereinafter simply referred to as an “MFP-B 1304”). An apparatus 1305 includes components provided on the virtual machine operation environment 913 (FIG. 9) (hereinafter simply referred to as an “MFP-B guest virtual machine 1305”).

In sequence SQ1306, the application A 1204 and the application B 1205 of the PC 1306 issue a service request to the MFP-A 1303. The MFP-A 1303 transfers a packet to the MFP-A virtual machine 1302. The packet is transmitted to the device control program 822 or the Java application 824 operating on the MFP-A virtual machine 1302 according to the type of the packet. In sequence SQ1307, the device control program 822 or the Java application 824 executes processing according to the packet.

In sequence SQ1308, the device control program 822 or the Java application 824 transmits a result of the service to a service request source apparatus. If the MFP-A 1303 has shifted to the power saving state and thus the packet cannot be processed, the application on the PC 1301 causes a functional error. In order to prevent this, the present exemplary embodiment executes the following processing for sifting to the power saving state.

Suppose here that an event for shifting to the power saving state has issued from the MFP-A 1303 in sequence SQ 1309. Here, in most cases, the power saving state is started according to a signal from a timer issued when no job has been input for a specific period of time. Alternatively, the power saving state is started according to a user operation of a corresponding operation switch.

In sequence SQ1310, the MFP-A 1303 issues a request for information about whether to start proxy processing by a virtual machine to the MFP-B 1304. After receiving the request from the MFP-A 1303, the MFP-B 1304 determines whether any resource is available in the guest virtual machine operation environment 910 including a plurality of guest virtual machines. If it is determined in sequence SQ1310 that any resource is available in the guest virtual machine operation environment 910, then the MFP-B 1304 reserves the available resource for the MFP-A 1303. In sequence SQ1311, the MFP-B 1304 transmits an ACK to the MFP-A 1303.

In sequence SQ1312, the MFP-A 1303 issues a SUSPEND request (a suspension request) to the MFP-A virtual machine 1302 (or to the virtual machine operation environment 802). Here, the suspension request is a request for suspending the status of the system including all contexts and resources on the virtual machine operation environment 802 as described above.

After receiving the suspension request in sequence SQ1313, the virtual machine operation environment 802 suspends the MFP-A virtual machine 1302. Then, after the MFP-A virtual machine 1302 has been successfully suspended, the processing advances to sequence SQ1314. In sequence SQ1314, the virtual machine operation environment 802 notifies that the MFP-A virtual machine 1302 has been successfully suspended to the MFP-A 1303. Thus, the MFP-A virtual machine 1302 shifts to the idle state and waits until an operation instruction is input.

In sequence SQ1315, the MFP-A 1303 transfers all the MFP-A virtual machines 1302 that have been suspended to the MFP-B 1304. In sequence SQ1316, the received MFP-A virtual machines 1302 are activated on the guest virtual machine operation environment 910 of the MFP-B 1304.

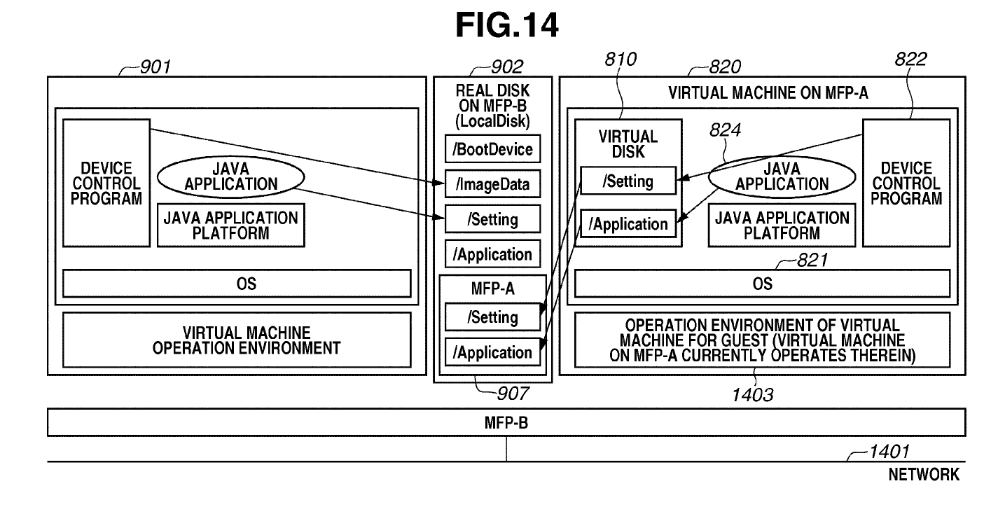

The software configuration of the MFP-B at this time is described in FIG. 14. FIG. 14 illustrates an example of the MFP-A virtual machine operating on the MFP-B according to the present exemplary embodiment. Referring to FIG. 14, a guest virtual machine operation environment 1403 is the same as the guest virtual machine operation environment 910 in FIG. 9. The virtual machine (application) 820, which is an example of a packet processing unit, is loaded and executed on the guest virtual machine operation environment 1403 as it is. In this regard, if the guest virtual machine operation environment 1403 and the virtual machine operation environment 802 are the same, the application 820 can operate independently from the hardware platform.

A network packet received from an external PC via a network 1401 is subjected to a determination by the MFP-B concerning a general transmission via the network such as routing. If the network packet has been addressed to the device control program 822 or the Java application 824, then the packet is transmitted to the kernel on the virtual machine software and then to each of the device control program 822 and the Java application 824. In a similar manner, the MFP-B can transmit the packet via the network. Here, the data stored on the virtual disk 810 includes the location on the network and information about the path.

When the device control program 822 or the Java application 824 accesses the virtual disk 810, an NFS packet is transmitted from the guest virtual machine operation environment 1403 to the system including the MFP-B.

However, since the reference target location on the network is the MFP-B in this case, the address is resolved within the system including the MFP-B. That is, the NFS packet is not transmitted to the external network 1401 and the local storage of the MFP-B is accessed.

By executing the above-described processing, the present exemplary embodiment can allow the device control program 822 and the Java application 824 to access the storage and execute the program by the same operation and operation state implemented on the MFP-A. With the above-described configuration, the present exemplary embodiment can activate and execute the program on the MFP-A with the MFP-B in the same normal operation state even when executed by the MFP-B.

Referring back to FIG. 13, in sequence SQ1317, the MFP-A virtual machine 1302 is activated. That is, in this state, the MFP-B can execute the processing by the MFP-A in proxy for the MFP-A as described above with reference to FIG. 14. In sequence SQ1318, the MFP-A virtual machine 1302 notifies the MFP-B 1304 that the MFP-A virtual machine 1302 has been normally activated.

In sequence SQ1319, the MFP-B 1304 notifies the MFP-A 1303 that the MFP-A virtual machine 1302 has been normally activated. After receiving the notification, the MFP-A 1303 recognizes that the server functions have been successfully transferred. In sequence SQ1320, the MFP-A 1303 shifts to the power saving state. After the MFP-A 1303 has shifted to the power saving state, the MFP-A virtual machine 1302, which shares the hardware resources with the MFP-A 1303, also shifts to the power saving state in sequence SQ1321.

In this state, in sequence SQ1322, the PC 1301 issues a request to the MFP-A. Note here that it is also useful if the MFP-A 1303 notifies a PC in communication therewith via the network that the MFP-A 1303 is about to shift to the power saving state and that the MFP-A 1303 has requested the MFP-B 1304 to execute the processing in proxy for the MFP-A 1303. In this case, the PC 1301 can recognize which MFP has shifted to the power saving state and which MFP is to operate in proxy for the MFP that has shifted to the power saving state. Therefore, in sequence SQ1322, the PC 1301 can transmit an inquiry of the MFP-A to the MFP-B 1304.

Furthermore, it is also useful if the MFP-A 1303 notifies a PC in communication therewith via the network that the MFP-A 1303 is about to shift to the power saving state. In this case, the PC 1301 can recognize which MFP has shifted to the power saving state. Therefore, in sequence SQ1322, the PC 1301 can transmit a request to the MFP-A to an MFP in communication therewith other than the MFP-A. After receiving the request to the MFP-A, the MFP that operates in proxy for the MFP-A (the MFP-B 1304 in FIG. 13) executes the processing corresponding to the request.

Furthermore, it is also useful, when the MFP-A 1303 is to shift to the power saving state, if the MFP-A 1303 does not notify a PC in communication therewith via the network that the MFP-A 1303 shifts to the power saving state. In this case, in sequence SQ1322, the PC 1301 always transmits a request addressed to the MFP (in this case, the MFP-A) to all MFPs in communication with the PC 1301 via the network. If the MFP-A is in the normal state (normal operation mode), the PC 1301 receives, from the MFP-A, a response to the request. On the other hand, if the MFP-A is already in the power saving state, the PC 1301 receives a response to the request from the MFP operating as a proxy MFP for the MFP-A (in this case, the MFP-B 1304).

After receiving the request from the PC 1301, in sequence SQ1323, the MFP-B 1304 transfers the request (transfers a packet) to the MFP-A virtual machine 1302, which is operating on the guest virtual machine operation environment 1403. In sequence SQ1324, the device control program 822 and the Java application 824 execute the processing corresponding to the request.

In sequence SQ1325, the MFP-A virtual machine 1302 operating on the guest virtual machine operation environment 1403 transmits the result of the processing executed according to the request to the PC 1301.

Note that as described above, the device control program 822 and the Java application 824 can access all the necessary data by accessing the virtual disk. That is, the device control program 822 and the Java application 824 can respond to the request. Accordingly, even when a job is input (issued) in the following case, the device control program 822 and the Java application 824 can execute the processing if the processing can be executed by software without using the specific hardware of the MFP-A.

In sequence SQ1326, the PC 1301 transmits a job to the MFP-A. In sequence SQ1327, the MFP-B 1304 transfers the job to the MFP-A virtual machine 1302 operating on the guest virtual machine operation environment 1403 (packet transfer processing). In sequence SQ1328, the MFP-A virtual machine 1302 operating on the guest virtual machine operation environment 1403 executes the processing according to the received job. If it is determined that the job uses the image processing apparatus on the MFP-A as a result of having analyzed the packet, then the MFP-A virtual machine 1302 operating on the guest virtual machine operation environment 1403 issues an instruction for restarting the MFP-A 1303 from the power saving state (restart request processing).

After receiving the instruction, in sequence SQ1329, the MFP-A 1303 returns from the power saving state to the normal operation mode. At the same time, in sequence SQ1330, the MFP-A virtual machine 1302 operating on the hardware of the MFP-A is activated in an idle state. However, since the MFP-A virtual machine 1302 has been in the suspended state in sequence SQ1313, the MFP-A virtual machine 1302 does not operate in this case.

In sequence SQ1331, the MFP-A 1303 issues a request for ending the proxy processing for the program (the MFP-A). After receiving the proxy processing ending request, the MFP-B 1304 transmits a suspension request to the MFP-A virtual machine 1302 operating on the guest virtual machine operation environment 1403 in sequence SQ1332. After receiving the suspension request, the MFP-A virtual machine 1302 operating on the guest virtual machine operation environment 1403 shifts to the suspended state for storing the current state in sequence SQ1333.

After completing the suspension processing, in sequence SQ1334, the MFP-A virtual machine 1302 operating on the guest virtual machine operation environment 1403 transmits an ACK to the MFP-B 1304 as a response. In sequence SQ1335, The MFP-B 1304 notifies the received ACK to the MFP-A 1303.

After receiving the ACK in response to the program proxy processing ending request, in sequence SQ1336, the MFP-A 1303 issues a request for acquiring the MFP-A virtual machine 1302 to the MFP-B 1304. In sequence SQ1337, the MFP-B 1304 instructs the MFP-B guest virtual machine 1305 to release the MFP-A virtual machine 1302. In sequence SQ1338, the MFP-A virtual machine returns to be the MFP-B virtual machine for guest. In sequence SQ1339, the MFP-B 1304 transfers the MFP-A virtual machine 1302, which has been suspended during processing the job, to the MFP-A 1303.

In sequence SQ1340, the MFP-A 1303 loads the received MFP-A virtual machine 1302 on the virtual machine operation environment of the MFP-A 1303 and releases the suspended state of the MFP-A virtual machine 1302. In sequence SQ1341, after being released from the suspended state, the MFP-A virtual machine 1302 resumes the operation executed at the time of the suspension on the MFP-B. Here, the MFP-A 1303 includes real hardware. Accordingly, the hardware can be normally accessed. Thus, the processing of the job that has been suspended is completed.

In sequence SQ1342, the MFP-A virtual machine 1302 transmits an ACK indicating that the job has been received to the PC 1301. In sequence SQ1343, the PC 1301 transmits job data. In sequence SQ1344, the MFP-A virtual machine 1302 executes the job.

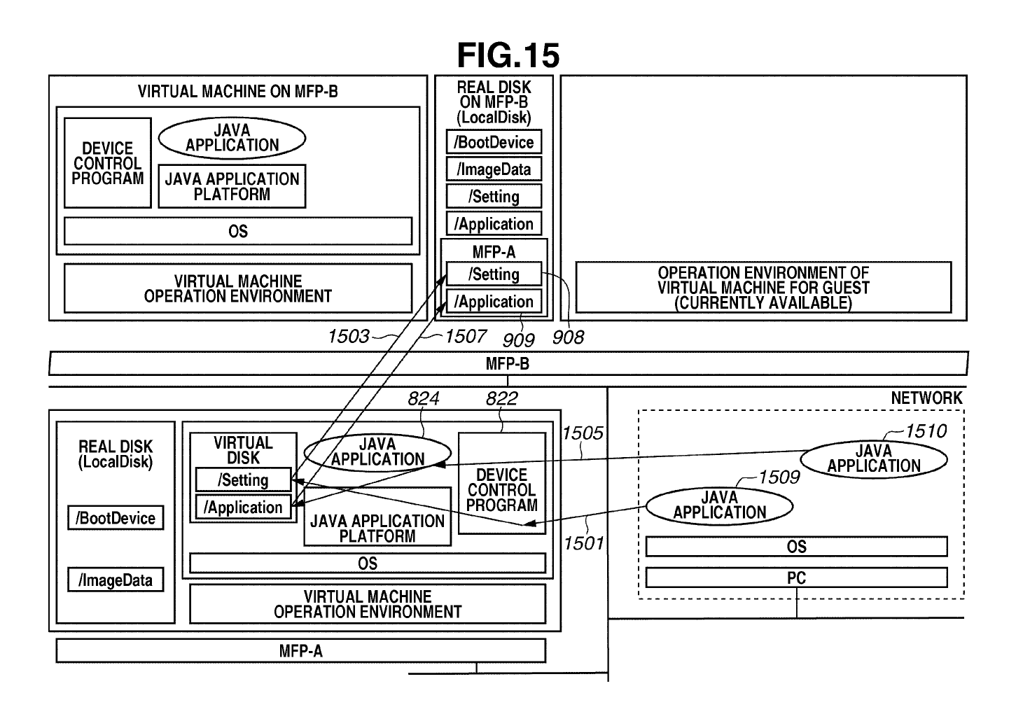

Now, the operation of software within each apparatus will be described in detail below with reference to FIGS. 15, 16, and 17. FIG. 15 illustrates a state where the MFP-A is in the normal state. Referring to FIG. 15, a Java application 1509 of the PC operates in cooperation with the device control program 822 on the MFP-A. A path 1501 is a path of transmission of a packet via the network. The processing is executed by the device control program 822. In using the storage device, the device control program 822 accesses the local virtual disk. Then, the device control program 822 accesses the entity of the data stored on the local real storage of the MFP-B via a path 1503.

A Java application 1510 of the PC operates in cooperation with the Java application 824 of the MFP-A. A path 1505 is a path for transmitting a packet via the network. The processing is executed by the Java application 824. In using the storage device, the Java application 824 accesses the local virtual disk. Then, the Java application 824 accesses the entity of the data stored on the local real storage on the MFP-B via a path 1507.

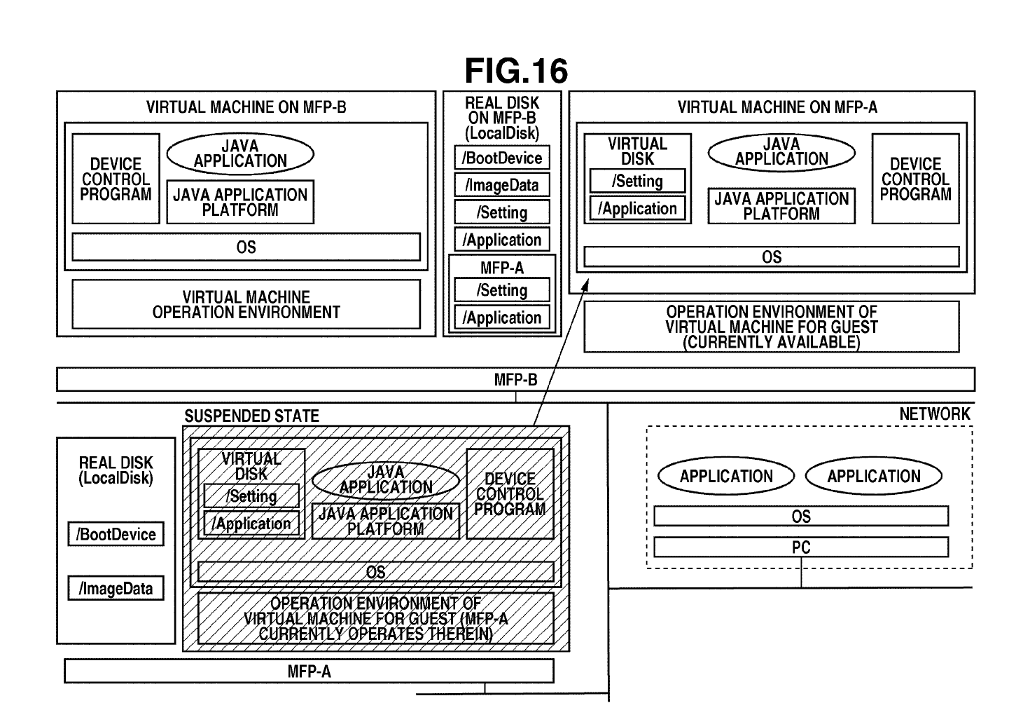

FIG. 16 illustrates the state where the virtual machine of the MFP-A is in the suspended state. In shifting to the power saving state or the power off state, the MFP-A transfers the virtual machine on the virtual machine operation environment of the MFP-A to the guest virtual machine operation environment of the MFP-B via the network.

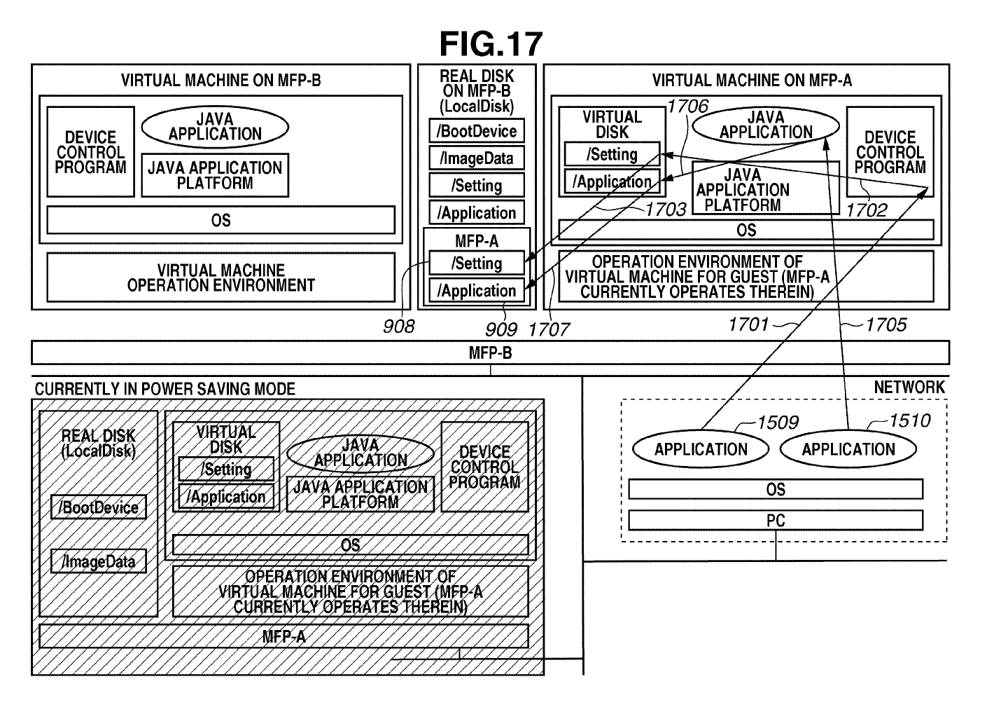

FIG. 17 illustrates the state after the MFP-A has shifted to the power saving state or the power off state. After shifting to the power saving state, the MFP-A suspends the function thereof while storing the current state. The device control program and the Java application of the MFP-A operate on the guest virtual machine operation environment of the MFP-B.

The application on the PC can communicate with the application on the MFP-A operating on the MFP-B via paths 1701 and 1705. The application of the MFP-A operating on the MFP-B can access the storage device in the same state as the state when operated on the MFP-A via paths 1702 and 1703 or paths 1706 and 1707.

With the above-described configuration, in an MFP network system utilizing a NAS, the present exemplary embodiment can shift a specific MFP to the power saving state without causing an error of a server function by integrally implementing a plurality of servers on one apparatus and effectively utilizing a storage service. Accordingly, the present exemplary embodiment can implement a system including a plurality of network apparatuses operating in cooperation with one another and shifting the apparatuses to the power saving state.

More specifically, according to the present exemplary embodiment having the above-described configuration, the MFP-A transmits information about the MFP-A, which is referred to by the virtual machine of the MFP-A, to the MFP-B. In shifting to the power saving state, the MFP-A transfers the virtual machine of the MFP-A to the MFP-B. Alternatively, if the MFP-A sharedly uses a storage with another MFP (the MFP-B), when the MFP-A shifts to the power saving state, the MFP-A transfers the virtual machine of the MFP-A to the MFP-B in which the information about the MFP-A referred to by the virtual machine of the MFP-A is stored (i.e., to the MFP which sharedly uses the storage with the MFP-A). Further alternatively, the MFP-A determines the MFP (the MFP-B) that sharedly uses the storage with the MFP-A as the destination of transfer of the virtual machine of the MFP-A. Furthermore, the MFP-A transfers the virtual machine of the MFP-A to the thus determined MFP-B when shifting to the power saving state. Then, the MFP-A shifts to the power saving state.

On the other hand, the MFP-B receives the information about the MFP-A, which is referred to by the virtual machine of the MFP-A (device information receiving processing), and also receives the virtual machine of the MFP-A. Furthermore, the MFP-B executes the virtual machine of the MFP-A. If a packet addressed to the MFP-A is received, the MFP-B transfers the received packet to the virtual machine of the MFP-A. Then, the virtual machine of the MFP-A, which operates on the MFP-B, refers to the information to process the packet.

Alternatively, the MFP-B shares the storage with the MFP-A and stores the information about the MFP-A on the storage unit. In this case, the MFP-B receives the virtual machine of the MFP-A from the MFP-A and executes the received virtual machine of the MFP-A. When a packet addressed to the MFP-A, the MFP-B transfers the packet to the virtual machine of the MFP-A. Accordingly, the virtual machine of the MFP-A operating on the MFP-B can process the packet by referring to the information.

With the above-described configuration, the present exemplary embodiment can provide a long sleep mode time for the apparatus (the MFP-A). Accordingly, the present exemplary embodiment can reduce the total power consumption of the system including a plurality of network apparatuses.

Furthermore, if the apparatus that responds in proxy for the MFP-A (the MFP-B in the present exemplary embodiment) has a gust virtual machine operation environment, the virtual machine of the proxy processing requesting apparatus (the MFP-A) can be stably and normally operate on the proxy apparatus (the MFP-B) even if versions or CPUs of the apparatuses may mutually differ. That is, the present exemplary embodiment can be applied if the versions or the CPUs of the MFP-A and the MFP-B may differ from each other.

As described above, the present exemplary embodiment can implement a system in which even after one MFP, which is an example of an information processing apparatus, has been shifted to the power saving state, the other information processing apparatus (another MFP, for example) can execute the service provided by the one MFP. A computer program for controlling MFP is stored in a computer-readable storage medium.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2008-048537 filed Feb. 28, 2008, which is hereby incorporated by reference herein in its entirety.

What is claimed is:

1. An information processing apparatus including a packet processing unit configured to process a packet, the information processing apparatus comprising:
a transmission unit configured to transmit apparatus information about the information processing apparatus, which is referred to by the packet processing unit, to another information processing apparatus; and
a transfer unit configured to transfer the packet processing unit to the another information processing apparatus when the information processing apparatus shifts to a power saving state.

2. The information processing apparatus according to claim 1, further comprising a power saving state shifting unit configured to shift the information processing apparatus to the power saving state.

3. The information processing apparatus according to claim 1, further comprising a returning unit configured to return the power saving state of the information processing apparatus to a normal operation state according to a normal operation state returning request from the another information processing apparatus.

4. An information processing apparatus including a packet processing unit configured to process a packet, the information processing apparatus comprising a transfer unit configured to transfer the packet processing unit to another information processing apparatus configured to store apparatus information about the information processing apparatus, which is referred to by the packet processing unit when the information processing apparatus shifts to a power saving state.

5. An information processing apparatus including a packet processing unit configured to process a packet, the information processing apparatus comprising:
a determination unit configured to determine another information processing apparatus configured to store apparatus information about the information processing apparatus, which is referred to by the packet processing unit, as a destination of transfer of the packet processing unit; and
a transfer unit configured to transfer the packet processing unit to the another information processing apparatus determined by the determination unit when the information processing apparatus shifts to a power saving state.

6. An information processing apparatus comprising:
a receiving unit configured to receive a packet processing unit that processes a packet from another information processing apparatus;
an apparatus information receiving unit configured to receive apparatus information about the another information processing apparatus, which is referred to by the packet processing unit, from the another information processing apparatus;
an execution unit configured to operate the packet processing unit received by the receiving unit; and
a packet transfer unit, if a packet addressed to the another information processing apparatus is received, configured to transfer the received packet to the packet processing unit,
wherein the packet processing unit is configured to process the packet by referring to the apparatus information according to the received packet.

7. The information processing apparatus according to claim 6, further comprising a transmission unit configured to transmit a request for returning the another information processing apparatus from the power saving state to a normal operation state to the another information processing apparatus.

8. The information processing apparatus according to claim 6, further comprising a transfer unit configured to transfer the packet processing unit to the another information processing apparatus after suspending processing by the packet processing unit according to a request from the another information processing apparatus.

9. An information processing apparatus comprising:
a storage unit configured to store apparatus information about another information processing apparatus;
a receiving unit configured to receive a packet processing unit that processes a packet from another information processing apparatus;
an execution unit configured to operate the packet processing unit received by the receiving unit; and
a packet transfer unit, when a packet addressed to the another information processing apparatus is received, configured to transfer the received packet to the packet processing unit,
wherein the packet processing unit is configured to process the packet by referring to the apparatus information stored on the storage unit according to the received packet.

10. The information processing apparatus according to claim 9, further comprising a transmission unit configured to transmit a request for returning the another information processing apparatus from the power saving state to a normal operation state to the another information processing apparatus.

11. The information processing apparatus according to claim 9, further comprising a transfer unit configured to transfer the packet processing unit to the another information processing apparatus after suspending processing by the packet processing unit according to a request from the another information processing apparatus.

12. An information processing system comprising a first information processing apparatus and a second information processing apparatus,
wherein the first information processing apparatus comprises:
a transmission unit configured to transmit apparatus information about the first information processing apparatus, which is referred to by a packet processing unit that processes a packet, to the second information processing apparatus; and
a transfer unit configured to transfer the packet processing unit to the second information processing apparatus when the first information processing apparatus shifts to a power saving state,
wherein the second information processing apparatus comprises:
an apparatus information receiving unit configured to receive the apparatus information from the first information processing apparatus;
a receiving unit configured to receive the packet processing unit from the first information processing apparatus;
an execution unit configured to operate the packet processing unit received by the receiving unit; and
a packet transfer unit, when a packet addressed to the first information processing apparatus is received, configured to transfer the received packet to the packet processing unit, and
wherein the packet processing unit is configured to process the received packet by referring to the apparatus information according to the packet.

13. An information processing system comprising a first information processing apparatus and a second information processing apparatus,
wherein the first information processing apparatus comprises a transfer unit, when the first information processing apparatus shifts to a power saving state, configured to transfer a packet processing unit that processes a packet to the second information processing apparatus configured to store apparatus information about the first information processing apparatus, which is referred to by the packet processing unit,
wherein the second information processing apparatus comprises:
a storage unit configured to store the apparatus information;
a receiving unit configured to receive the packet processing unit from the first information processing apparatus;
an execution unit configured to operate the packet processing unit received by the receiving unit; and
a packet transfer unit, when a packet addressed to the first information processing apparatus is received, configured to transfer the received packet to the packet processing unit,
wherein the packet processing unit is configured to process the packet by referring to the apparatus information stored on the storage unit according to the packet.

14. An information processing system comprising a first information processing apparatus and a second information processing apparatus,
wherein the first information processing apparatus comprises:
a determination unit, when the first information processing apparatus shifts to a power saving state, configured to determine the second information processing apparatus configured to store apparatus information about the first information processing apparatus, which is referred to by a packet processing unit that processes a packet, as a destination of transfer of the packet processing unit; and
a transfer unit configured to transfer the packet processing unit to the second information processing apparatus determined by the determination unit,
wherein the second information processing apparatus comprises:
a storage unit configured to store apparatus information about the first information processing apparatus;
a receiving unit configured to receive the packet processing unit from the first information processing apparatus;
an execution unit configured to operate the packet processing unit received by the receiving unit; and
a packet transfer unit, when a packet addressed to the first information processing apparatus is received, configured to transfer the received packet to the packet processing unit,
wherein the packet processing unit is configured to process the packet by referring to the apparatus information stored on the storage unit according to the received packet.

15. An information processing method for an information processing apparatus including a packet processing unit configured to process a packet, the information processing method comprising:
transmitting apparatus information about the information processing apparatus, which is referred to by the packet processing unit, to another information processing apparatus; and
transferring the packet processing unit to the another information processing apparatus when the information processing apparatus shifts to a power saving state.

16. An information processing method for an information processing apparatus including a packet processing unit configured to process a packet, the information processing method comprising transferring the packet processing unit to another information processing apparatus configured to store apparatus information about the information processing apparatus, which is referred to by the packet processing unit when the information processing apparatus shifts to a power saving state.

17. An information processing method for an information processing apparatus including a packet processing unit configured to process a packet, the information processing method comprising:
determining another information processing apparatus configured to store apparatus information about the information processing apparatus, which is referred to by the packet processing unit, as a destination of transfer of the packet processing unit; and
transferring the packet processing unit to the determined another information processing apparatus when the information processing apparatus shifts to a power saving state.

18. An information processing method for an information processing apparatus, the information processing method comprising:
receiving a packet processing unit that processes a packet from another information processing apparatus;
receiving apparatus information about the another information processing apparatus, which is referred to by the packet processing unit, from the another information processing apparatus;
operating the received packet processing unit;
transferring, if a packet addressed to the another information processing apparatus is received, the received packet to the packet processing unit; and
processing the packet by referring to the apparatus information according to the received packet.

19. An information processing method for an information processing apparatus, the information processing method comprising:
receiving a packet processing unit that processes a packet from another information processing apparatus;
operating the received packet processing unit;
transferring, if a packet addressed to the another information processing apparatus is received, the received packet to the packet processing unit; and
causing the packet processing unit to process the packet by referring to apparatus information stored on a storage unit configured to store the apparatus information about the another information processing apparatus according to the packet.

20. A computer-readable storage medium storing instructions which, when executed by a computer including a packet processing unit that processes a packet, cause the computer to execute operations comprising:
transmitting apparatus information about the computer, which is referred to by the packet processing unit, to another computer; and
transferring the packet processing unit to the another computer when the computer shifts to a power saving state.

21. A computer-readable storage medium storing instructions which, when executed by a computer including a packet processing unit that processes a packet, cause the computer to execute operations comprising transferring the packet processing unit to another computer configured to store apparatus information about the computer, which is referred to by the packet processing unit when the computer shifts to a power saving state.

22. A computer-readable storage medium storing instructions which, when executed by a computer including a packet processing unit that processes a packet, cause the computer to execute operations comprising:
determining another computer configured to store apparatus information about the computer, which is referred to by the packet processing unit, as a destination of transfer of the packet processing unit; and
transferring the packet processing unit to the determined another computer when the computer shifts to a power saving state.

23. A computer-readable storage medium storing instructions which, when executed by a computer including a packet processing unit that processes a packet, cause the computer to execute operations comprising:
receiving a packet processing unit that processes a packet from another computer;
receiving apparatus information about the another computer, which is referred to by the packet processing unit, from the another computer;
operating the received packet processing unit;
transferring, if a packet addressed to the another computer is received, the received packet to the packet processing unit; and
processing the packet by referring to the apparatus information according to the received packet.

24. A computer-readable storage medium storing instructions which, when executed by a computer including a packet processing unit that processes a packet, cause the computer to execute operations comprising:
receiving a packet processing unit that processes a packet from another computer;
operating the received packet processing unit;
transferring, if a packet addressed to the another computer is received, the received packet to the packet processing unit; and
causing the packet processing unit to process the packet by referring to apparatus information stored on a storage unit configured to store the apparatus information about the another computer according to the packet.
